(19) United States
(12) Patent Application Publication
(10) Pub. No.: US 2022/0345229 A1
(43) Pub. Date: Oct. 27, 2022

(54) System for Mitigating Unwanted Emissions in a Multi-RF Processing Chain System

(71) Applicant: Phazr, Inc., Allen, TX (US)

(72) Inventor: Sidharth Balasubramanian, Garland, TX (US)

(21) Appl. No.: 17/635,371

(22) PCT Filed: Sep. 1, 2020
(86) PCT No.: PCT/US2020/048930

§ 371 Date: Feb. 14, 2022

Related U.S. Application Data
(60) Provisional application No. 62/904,899, filed on Sep. 24, 2019.

(51) Int. Cl. H04B 15/06; H04B 7/0413

(52) U.S. Cl. CPC H04B 15/06; H04B 7/0413; H04W 88/08

(57) ABSTRACT

Disclosed is a system for mitigating unwanted emissions in an integrated antenna in which the uplink and downlink RF processing chains are located in close proximity and shielding is impractical. The system involves orienting the uplink and downlink processing chains and physically locating them relative to each other so that applying selective phase biases to their local oscillators results in local oscillator leakage from adjacent RF processing chains to have an out of phase relationship relative to each other. This mitigates unwanted emission from local oscillator signals leakage from the RF processing chains' mixers by angularly dispersing the unwanted emissions and attenuating the unwanted emissions through destructive interference.

### CROSS REFERENCE TO RELATED APPLICATIONS

This application claims priority from U.S. provisional application No. 62/904,899, filed Sep. 24, 2019, entitled “SYSTEM FOR MITIGATING UNWANTED EMISSIONS IN A MULTI-RF PROCESSING CHAIN SYSTEM”, assigned to the present assignee and incorporated herein by reference.

### BACKGROUND OF THE INVENTION

### Field of the Invention

The present invention relates to wireless communications, and more particularly, to a system for mitigating unwanted emissions in multiple RF paths in close proximity.

### Related Art

The advent of 5G NR (New Radio) introduces the use of millimeter wave (mmWave) bands in telecommunications, which offer superior performance in bandwidth and latency. A challenge related to mmWave is that the reduced propagation distance of mmWave implementations requires the deployment of more base stations in closer proximity to each other. An opportunity with mmWave technology is that the wavelengths involved allow for phased array antennas with massive MIMO capability to be deployed within compact integrated units that can be deployed in locations of opportunity in urban environments (e.g., on lamp posts, etc.) and inside buildings.

These integrated units have their RF processing chains placed in close proximity to each other as well as to the antennas within the unit. Having the RF processing chains in close proximity presents certain challenges. Among them is the problem of unwanted emissions from the RF chain. Local oscillator (LO) signal leakage from the mixers within the RF chains causes unwanted radiation at the LOs' fundamental frequencies as well as at their harmonics. A conventional solution to the unwanted emission problem involves ample shielding around the RF chain circuitry. This conventional solution may work fine for base stations in which the antenna is located remotely from the RF chains and there is no need for integrating the RF chains and the antennas within a single compact enclosure, or in which there is sufficient space for shielding of the RF mixer and local oscillator circuits. For mmWave systems, sufficient shielding of the RF chains may not be feasible due to the restricted envelope of the compact enclosure.

Accordingly, what is needed is a system for mitigating unwanted emissions from RF chain circuitry within an integrated antenna without relying on shielding.

### SUMMARY OF THE INVENTION

An aspect of the present invention involves a wireless base station. The base station comprises a first plurality of RF processing chains, each of the first plurality of RF processing chains having a first local oscillator input phase and a first mixer output phase; and a second plurality of RF processing chains, each of the second plurality of RF processing chains having a second local oscillator input phase and a second mixer output phase, wherein the first plurality of RF processing chains and second plurality of RF processing chains are physically arranged, and the first local oscillator input phase and second local oscillator input phases are selected, so that the first mixer output phase of a given first RF processing chain has an out-of-phase relationship with the second mixer output phase of an adjacent second RF processing chain.

Another aspect of the present invention involves a wireless base station. The base station comprises a phase selector means; a first plurality of RF processing means, each of the first plurality of RF processing means coupled to the phase selector means; and a second plurality of RF processing means, each of the second plurality of RF processing means coupled to the phase selector means, wherein the phase selector means provides a first input phase bias to each of the first plurality of RF processing means and a second input phase bias to each of the second plurality of RF processing means and wherein the first plurality of RF processing means and the second plurality of RF processing means are arranged so that a first unwanted emission corresponding to each of the first plurality of RF processing means has an out-of-phase relationship with a second unwanted emission corresponding to each of the second plurality of RF processing means.

### BRIEF DESCRIPTION OF THE DRAWINGS

FIG. 1 illustrates an exemplary system for mitigating unwanted RF emissions according to the disclosure.

FIG. 2 illustrates exemplary RF uplink (UL) and downlink (DL) processing chains according to the disclosure.

FIG. 3A illustrates an exemplary physical arrangement of adjacent RF chains along with possible differential phase biases for mitigating unwanted RF emissions according to the disclosure.

FIG. 3B illustrates an exemplary variation of the physical arrangement of FIG. 3A in which the adjacent RF chains alternate in orientation.

FIG. 4 illustrates an exemplary 5G NR protocol stack for both uplink and downlink, including the processing steps in the protocol stack in which the system for mitigating unwanted RF emissions may be deployed.

### DESCRIPTION OF EXEMPLARY EMBODIMENTS

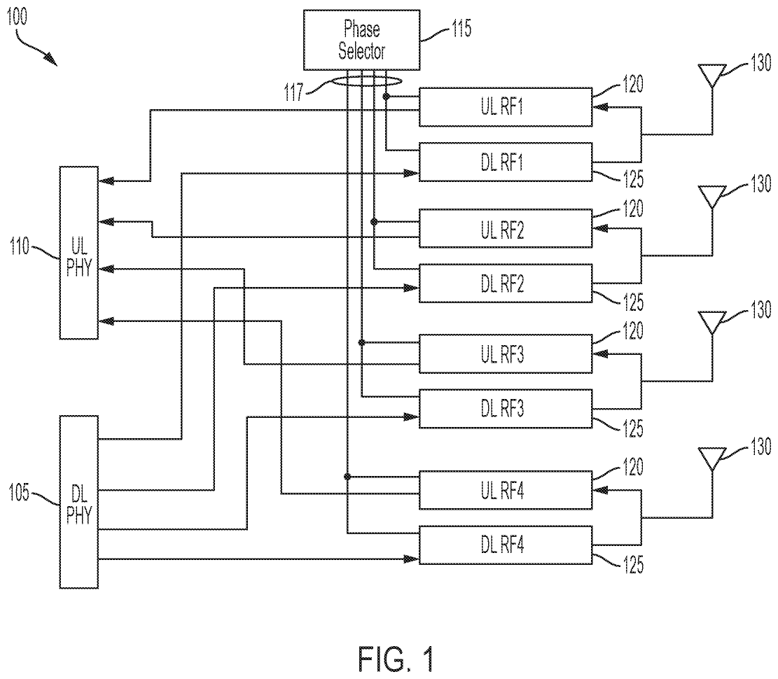

FIG. 1 illustrates an exemplary system 100 for mitigating unwanted RF emissions according to the disclosure. System 100 includes a portion of the downlink PHY layer 105; a portion of the uplink PHY layer 110; a phase selector module 115; a plurality of uplink RF processing chains 120 and a plurality of downlink RF processing chains 125 arranged in pair (four chain pairs in this example), wherein each RF chain pair 120/125 is coupled to an antenna 130. Phase select module 115 may be coupled to each of the RF uplink/downlink pairs 120/125 such that a given pair 120/125 is provided a phase bias input 117 from the phase select module 115.

Phase selector module 115, downlink PHY layer 105, and uplink PHY layer 110 may comprise machine readable instructions that are encoded within one or more non-transitory memory devices and executed on one or more processors that perform their respective described functions. As used herein, “non-transitory memory” may refer to any tangible storage medium (as opposed to an electromagnetic or optical signal) and refer to the medium itself, and not to a limitation on data storage (e.g., RAM vs. ROM). For example, non-transitory medium may refer to an embedded volatile memory encoded with instructions whereby the memory may have to be re-loaded with the appropriate machine-readable instructions after being power cycled. Further, each of these components may be deployed within its compute environment using container technology. Alternatively, or in combination, one or more of the components of system 100 (apart from antennas 130) may be implemented in Field Programmable Gate Arrays (FPGAs), Application-Specific Integrated Circuits (ASICs), dedicated circuitry, and/or software stored as machine readable instructions that are executed on one or more processors. Further, phase selector module 115 may be a configuration whereby the phase bias inputs 117 are hardcoded in each FPGA implementation of uplink RF chain 120 and downlink RF chain 125. It will be understood that such variations are possible and within the scope of the disclosure.

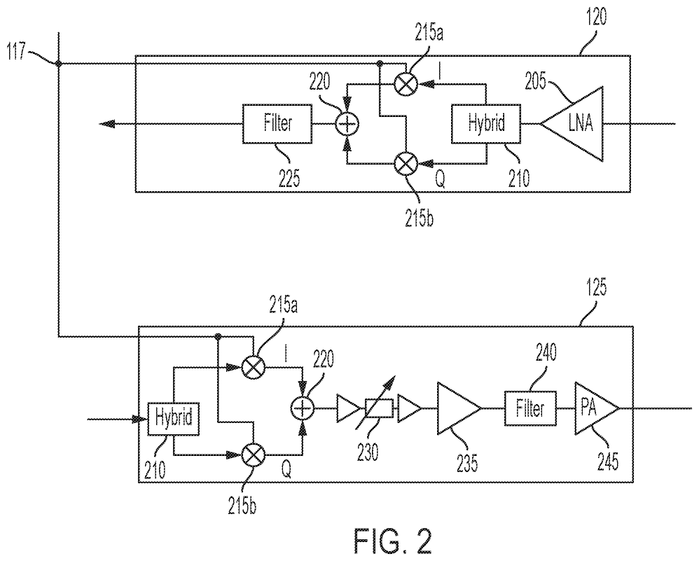

FIG. 2 illustrates an exemplary uplink RF chain 120 and downlink RF chain 125 according to the disclosure. The illustrated chain pair 120/125 may be conventional image reject mixer implementations that have the additional feature of a phase bias input 117 from phase selector 115. Uplink RF chain 120 has a low noise amplifier 205 and a hybrid splitter 210, which splits the uplink signal into In-phase and Quadrature components, each of which are downconverted to an Intermediate Frequency (IF) by mixers 215a and 215b and then recombined in adder 220 and fed to filter 225. The resulting output of uplink RF chain 120 is an IF uplink signal that is sent to the uplink PHY layer 110. Although image reject mixer implementations are illustrated for chain pair 120/125, it will be understood that other mixer implementations having a phase bias input 117 are possible and within the scope of the disclosure.

Downlink RF chain 125 has a hybrid splitter 210, which spits the incoming Intermediate Frequency (IF) signal into In-phase and Quadrature signals, each of which is upconverted to RF by mixers 215a and 215b and combined in adder 220. The combined RF signal is amplified by variable gain amplifier 230, driver amplifier 235, applied to filter 240, and boosted by power amplifier 245. The conversion from RF to IF of the downlink I/Q signal is performed with a phase bias provided by phase bias input 117.

The addition of the phase bias input 117 provides a selected phase rotation to the Local Oscillators within mixers 215a and 215b within uplink RF chain 120 and downlink RF chain 125, as described below.

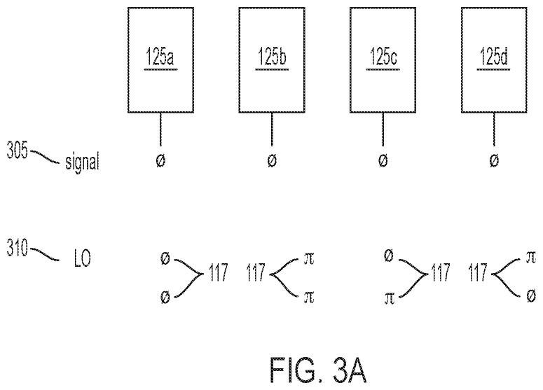

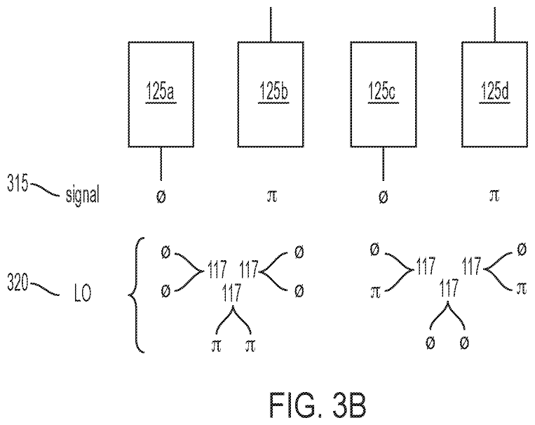

FIG. 3A illustrates an exemplary physical arrangement of adjacent RF chains 120/125 along with possible differential phase bias inputs 117 for mitigating unwanted RF emissions according to the disclosure. For each individual RF chain 120/125, the local oscillators in mixers 215a/b cause unwanted RF emissions, not only at their respective fundamental frequencies, but also at their respective harmonics. These unwanted emissions from mixers 215a/b, caused by leakage of the local oscillator signals, not only contaminate the RF environment of the base station in which system 100 is deployed, they also “eat into” the total allowable RF emission budget allowable for the base station.

As illustrated in FIG. 3A, the RF chains 120/125 are adjacent and aligned in the same direction. In this example, the input downlink signal 305 to each of the RF chains 120/125a-d are of equal phase (represented by a phase difference of zero to each). Further to this example, phase bias input 117 for the respective RF chains 120/125 are given different phase patterns 310 of local oscillator phase biases of 0 and π. In option 1a, the adjacent RF chains 120/125 are given alternating phase inputs 117 of 0 and π such that RF chains 120/125a/c are given a phase input of 0, and RF chains 120/125b/d are given a phase input of π. In option 1b, the RF chains 120/125a-d are given phase inputs 117 such that RF chains 120/125a/d are given a phase input of 0, and RF chains 120/125 b/c are given a phase input of π.

FIG. 3B illustrates a variation of the physical arrangement of FIG. 3A in which the RF chains 120/125 alternate in orientation by 180 deg, providing signal phase biases 315 of 0 and π. Due to their respective orientations, RF chains 120/125a/c have a signal input phase bias of 0, and RF chains 120/125b/d have a signal input bias of π. In this configuration, there are three possible patterns 320 of local oscillator phase bias inputs 117 for RF chains 120/125a-d. Each of options 1b, 2b, and 3b, in conjunction with the signal biases 315, provide patterns of alternative local oscillator phase inputs 117 of 0 and π.

The combination of local oscillator phase inputs 117, physical placement of the RF chains 120/125, and the respective orientations of the RF chains 120/125, collectively provide for destructive interference between the unwanted emissions from the mixers 215a/b caused by leakage from their respective local oscillators. This may have the effect of angularly dispersing the aggregate unwanted emissions of the local oscillators of the RF chains 120/125.

The effect of each configuration and each option within each configuration is that the unwanted emissions caused by local oscillator signal leakage from the respective mixers 215a/b of adjacent RF chains 120/125 are in an out-of-phase relationship. The phase selector module 115 may provide arbitrary phase bias inputs 117 to impart the desired out-of-phase relationship. An example of an out-of-phase relationship may include being reversed in phase by 180 degrees. Other examples include 0/90/180/270 degrees and 0/180/45/135 degrees. Having the unwanted emissions from adjacent RF processing chains 120/125 in an out-of-phase relationship causes destructive interference that mitigates overall unwanted emissions from system 100.

In a further exemplary variation, system 100 may be configured to create out-of-phase relationships between an uplink RF chain 120 and a corresponding adjacent downlink RF processing chain 125. It will be understood that such variations are possible and within the scope of the disclosure.

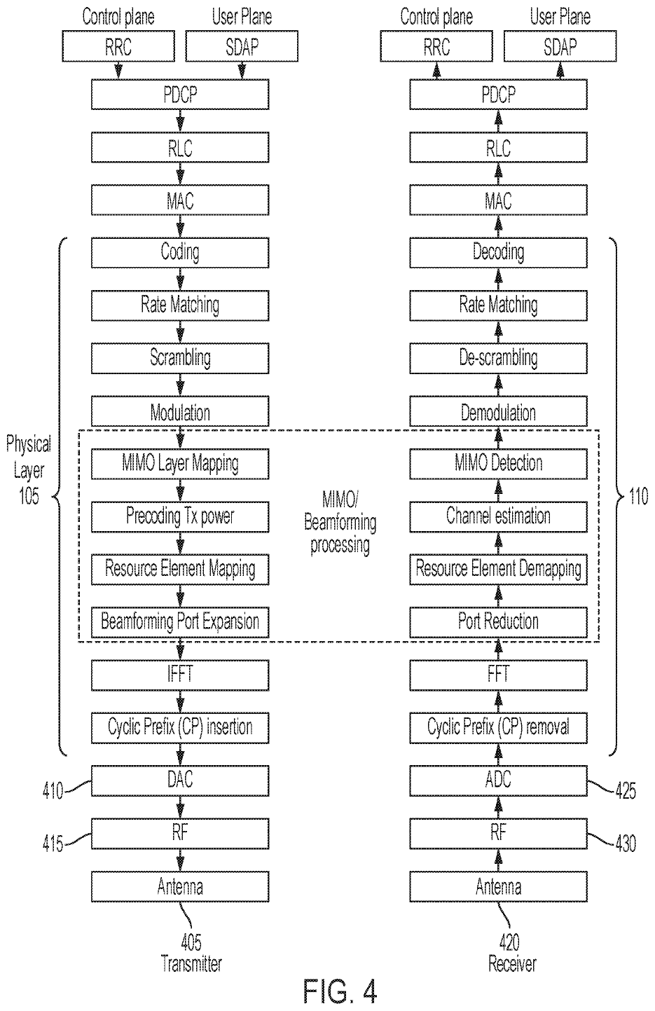

FIG. 4 illustrates an exemplary 5G NR protocol stack for both uplink 420 and downlink 405, including the processing steps in the protocol stack in which system 100 may be deployed. Referring to the downlink protocol stack 405, the downlink RF chains 125 may deployed within RF step 415, and phase selector 115 (not shown) may be implemented anywhere within the compute environment with its phase bias inputs 117 provided to RF step 415. In this case, in DAC step 410, the processors implement digital upconversion from baseband to IF and convert the signal from digital to analog. Accordingly, the input to RF step 415 is an analog IF signal. In the uplink protocol stack 420, the uplink RF chains 120 may be deployed within RF step 430. And as with the downlink example, the phase selector 115 (not shown) may provide its phase bias inputs 117 to RF block 430.

The addition of system 100 to the 5G protocol stack implementation of FIG. 4 may provide the following capability. The processors executing downlink protocol stack 405 and uplink protocol stack 420 may execute instructions to perform digital beamforming according to the 3GPP specification. With the addition of phase bias inputs 117 from phase selector 115, the local oscillators of the mixers 125a/b within adjacent uplink/downlink RF chains 120/125 cancel out so that the unwanted emissions from the local oscillators may be angularly dispersed and attenuated by destructive interference. This prevents unwanted emissions from the local oscillators from contaminating the desired beams created by digital beamforming.

It will be understood that the phase biases introduced to the local oscillators according to the disclosure may affect the digital beamforming performed further up protocol stacks 405 and 420. However, the processors may compensate for these added phase biases by retrieving channel state information from the UEs (now shown) connected to the base station, which will have the phase biases provided by phase selector 115 embedded therein. Accordingly, having identified the phase biases measured by the UEs, the processors may automatically back out those phase biases in the precoding performed within PHY layers of protocol stack 405/420.

In an example, the uplink RF processing chains 120 and downlink RF processing chains 125 are configured to operate in mmWave frequencies, and the local oscillators of mixers 215a/b are configured to operate at 24 GHz. However, it will be understood that the disclosure may also apply to other frequency bands. Further, although the disclosure discusses a 5G exemplary implementation, it will be understood that the disclosure may also apply to other telecommunications protocols and radio systems, such as radar. And although the above discussion pertains to a 5G base station, it will be understood that it may equally apply to radio systems in which multiple RF processing chains are located in close proximity, such as in an integrated antenna, in which extensive shielding is not a viable option

Variations to system 100 are possible and within the scope of the disclosure. For example, the uplink/downlink pairs 120/125 illustrated in FIG. 1 might not be provided the same phase bias input 117, as long as the given uplink/downlink RF chain 120/125 have the phase of its unwanted emission 180 out of phase from the unwanted emission of its adjacent neighboring respective uplink/downlink RF chain 120/125. Further, phase selector module 115 may be configurable so that it may change the specific phases at the phase bias inputs 117 it provides to uplink/downlink RF chains 120/125, provided that the aforementioned 180 phase difference between adjacent respective uplink/downlink RF chains 120/125 is maintained. It will be understood that such variations are possible and within the scope of the invention.

1. A wireless base station, comprising:
a first plurality of RF processing chains, each of the first plurality of RF processing chains having a first local oscillator input phase and a first mixer output phase; and
a second plurality of RF processing chains, each of the second plurality of RF processing chains having a second local oscillator input phase and a second mixer output phase,
wherein the first plurality of RF processing chains and second plurality of RF processing chains are physically arranged, and the first local oscillator input phase and second local oscillator input phases are selected, so that the first mixer output phase of a given first RF processing chain has an out-of-phase relationship with the second mixer output phase of an adjacent second RF processing chain.

2. The wireless base station of claim 1, where in the first and second plurality of RF processing chains comprise downlink RF processing chains.

3. The wireless base station of claim 1, where in the first and second plurality of RF processing chains comprise uplink RF processing chains.

4. The wireless base station of claim 1, wherein the first plurality of RF processing chains comprise downlink RF processing chains, and wherein the second plurality of RF processing chains comprise uplink RF processing chains.

5. A wireless base station, comprising:
a phase selector means;
a first plurality of RF processing means, each of the first plurality of RF processing means coupled to the phase selector means; and
a second plurality of RF processing means, each of the second plurality of RF processing means coupled to the phase selector means;
wherein the phase selector means provides a first input phase bias to each of the first plurality of RF processing means and a second input phase bias to each of the second plurality of RF processing means, and wherein the first plurality of RF processing means and the second plurality of RF processing means are arranged so that a first unwanted emission corresponding to each of the first plurality of RF processing means has an out-of-phase relationship with a second unwanted emission corresponding to each of the second plurality of RF processing means.

6. The wireless base station of claim 5, wherein the first plurality of RF processing means and the second plurality of RF means are interleaved.

7. The wireless base station of claim 5, wherein the first plurality of RF processing means and the second plurality of RF means are oriented in opposite directions.

8. A wireless base station, comprising:
a first plurality of RF processing chains each having a first local oscillator;
a second plurality of RF processing chains each having a second local oscillator;
a phase selector configured to provide a first input phase bias to the first local oscillators and a second input phase bias to the second local oscillators,
wherein the first plurality of RF processing chains and the second plurality of RF processing chains are arranged so that a first unwanted emission corresponding to each of the first plurality of RF processing chains has an out-of-phase relationship with a second unwanted emission corresponding to each of the second plurality of RF processing chains.

9. The wireless base station of claim 8, wherein the first and second input phase biases selectively rotate the phases of the respective first and second plurality of local oscillators so that the arrangement of the first and second plurality of RF processing chains provides for a destructive interference between the first and second unwanted emissions.

10. The wireless base station of claim 8, where in the first and second plurality of RF processing chains comprise downlink RF processing chains.

11. The wireless base station of claim 8, where in the first and second plurality of RF processing chains comprise uplink RF processing chains.

12. The wireless base station of claim 8, wherein the first plurality of RF processing chains comprise downlink RF processing chains, and wherein the second plurality of RF processing chains comprise uplink RF processing chains.

13. The wireless base station of claim 8, wherein the first plurality of RF processing chains and the second plurality of RF processing chains are interleaved.
